(19) United States
(12) Patent Application Publication
(10) Pub. No.: US 2026/0365042 A1
(43) Pub. Date: Nov. 19, 2026

(54) METHOD FOR OPERATING A DRIVE SYSTEM OF A MOTOR VEHICLE COMPRISING AT LEAST ONE ELECTRIC DRIVE UNIT

(71) Applicant: ZF Friedrichshafen AG, Friedrichshafen (DE)

(72) Inventors: Christian Mittelberger, Ravensburg (DE); Ahmed El-Gharabawy, Ravensburg (DE); Bernhard Nienaber, Friedrichshafen (DE); Oussama Jabloun, Friedrichshafen (DE); Franz Prenner, Friedrichshafen (DE); Stefan Bemetz, Wangen im Allgäu (DE); Franz Bitzer, Friedrichshafen (DE); Manuel Burkhart, Meckenbeuren (DE)

(73) Assignee: ZF Friedrichshafen AG, Friedrichshafen (DE)

(21) Appl. No.: 19/674,955

(22) Filed: May 12, 2026

(30) Foreign Application Priority Data
May 13, 2025 (DE) 10 2025 118 398.8

(51) Int. Cl. B60L 50/60; B60L 7/16

(52) U.S. Cl. CPC B60L 50/60; B60L 7/16; B60L 2240/42; B60L 2240/486; B60L 2240/549; B60L 2260/26

(57) ABSTRACT

A method is provided for operating a drive system of a motor vehicle having at least one electric drive unit, a plurality of electric machines, and an electrical energy storage device are integrated in a supply network. A forthcoming operating mode of the motor vehicle is detected. In advance of that operating mode, in a preliminary phase, a load is reduced in at least one of the electric machines of the at least one drive unit. In the supply network, a current distribution from the energy storage device to the electric machines is changed from a first, fixed distribution to a second distribution. Thereby, during the preliminary phase a smaller current fraction is delivered by the second distribution to the at least one electric machine whose load is to be reduced, than by the first distribution.

### RELATED APPLICATIONS

This application claims the benefit of and right of priority under 35 U.S.C. § 119 to German Patent Application no. 10 2025 118 398.8, filed on 13 May 2025, the contents of which are incorporated herein by reference in its entirety.

### FIELD OF THE DISCLOSURE

The invention relates to a method for operating a drive system of a motor vehicle comprising at least one electric drive unit in which, in each case, a plurality of electric machines and an electric storage device are integrated in a supply network. Furthermore, the invention relates to a control unit for a drive system of a motor vehicle, a computer program product, and a data carrier.

### BACKGROUND

In hybrid and electric vehicles, electric drive units are provided in drive systems, which include one or sometimes several electric machines. Frequently, to work in certain operating modes of the motor vehicle concerned, a controlled load reduction of the electric machines in question is carried out. Thus, for example, the load reduction is carried out in order to change the electric machine concerned from electric motor to generator operation, in which the electric machine, at the same time as the recuperation of electrical energy that takes place, also produces a corresponding braking torque in the drive system concerned. In a drive system also comprising a motor vehicle transmission, such a change to generator operation is carried out for example in order to carry out a gearshift in the motor vehicle transmission, since by means of the electric machine concerned, a braking torque of such type is produced so that a rotation speed synchronization required for the gearshift takes place. Usually in such a case, the electrical energy produced during generator operation is fed to an energy storage device of the drive system, but a situation can arise in which the energy storage device cannot take up any electrical energy, for example owing to its charged condition or due to the prevailing temperatures.

WO 2017/186505 A1 describes a method for operating a drive system of a motor vehicle. In this case the drive system comprises an electric drive unit in which, besides an electrical energy storage device, a plurality of electric machines can be integrated in a supply network. During the course of shifting processes in a motor vehicle transmission of the drive system, one of the electric machines is used for the synchronization of rotation speeds, for which purpose the electric machine is deliberately operated in generator mode. In that case the generator operation can take place in a first brake operation mode or in a second brake operation mode, which compared with the first brake operation mode takes place with greater power loss of the electric machine. The choice of the brake operation mode is made among other things as a function of the charge condition of the energy storage device. If the charge condition is above a charge condition limit, then the generator operation is carried out in the second brake operation mode so that owing to the elevated power loss, charging of the energy storage device is suppressed.

### SUMMARY

Starting from the above-described prior art, the purpose of the present invention is now, with at least one electric drive unit of a moreover drive system, to optimize the operation of a plurality of electric machines while carrying out an operating mode.

From the process technology standpoint, this objective is achieved by a method of operating a drive system of a motor vehicle as disclosed herein, in combination with its characterizing features. From the equipment technology standpoint, the objective is achieved with a control unit as disclosed herein, in combination with its characterizing features. The dependent claims that follow them in each case describe respective advantageous further developments of the invention. In addition, the present disclosure is directed to a computer program product and a data carrier.

According to one aspect of the present disclosure, a method of operating a drive system of a motor vehicle, the drive system has at least one electric drive unit into which a plurality of electric machines and an electrical energy storage device are integrated in a supply network. Thus, the method according to the invention is applied with a drive system of a motor vehicle, wherein the drive system comprises at least one electric drive unit in which a plurality of electric machines and an electrical energy storage device are provided. In particular, each electric machine can be operated on the one hand as an electric motor by which the electrical energy supplied to the electric machine concerned is converted to mechanical energy, and on the other hand as a generator by which the electric machine concerned converts mechanical energy into electrical energy. In particular, the operation of each electric machine is regulated by an associated power electronics unit, preferably comprising an inverter or rectifier. More preferably, the at least one electric drive unit comprises precisely two electric machines.

The drive system can be designed for use in a purely electric vehicle, since in the drive system only the at least one electric machine drive unit is provided for driving the motor vehicle. Alternatively, however, the drive system can be designed for use in a hybrid vehicle, for which purpose, besides the at least one electric drive unit, a further drive unit is part of the drive system, for example in the form of a combustion engine.

According to one embodiment, a drive system comprises at least one electric drive unit. In the at least one electric drive unit the plurality of electric machines and the electrical energy storage device are integrated into a supply network in which, in the supply network, each electric machine can in particular be connected to the energy storage device in order to supply electrical energy from the energy storage device to the electric machine concerned when the latter is operated as an electric motor, or in order to feed electrical energy into the energy storage device when the electric machine is operated as a generator. The respective connection can be formed, in particular, by way of the intermediate power electronics unit associated with the electric machine concerned. Preferably, the supply network is an on-board network of the motor vehicle or part of an on-board network of the motor vehicle. In the context of the invention the drive system can comprise just one drive unit or even a plurality of drive units, which then comprise several electric machines which are then integrated together with a respective electrical energy storage device in a common supply network. The electric drive unit in each case can be associated with a respective electrically powered drive axle of the motor vehicle.

In the at least one electric drive unit, the energy storage device preferably consists of at least one battery, although the energy storage device can comprise just one battery or a plurality of batteries, which in that case can even be positioned spatially separated from one another.

In accordance with methods of operation, the invention now embodies the technical principle that when it is detected that an operating mode is forthcoming in a motor vehicle, to carry it out a load reduction of at least one electric machine of the at least one drive unit must be carried out in advance, in a preliminary phase, whereby in the supply network a current distribution by the energy storage device to the electric machines is changed from a first, fixed distribution to a second distribution such that during the preliminary phase a smaller current proportion is assigned by the second distribution than by the first distribution to the at least one electric machine in which the load is to be reduced.

In other words, when a forthcoming operating mode of the motor vehicle is detected, then to bring it about, before it is actually implemented, namely, during a preliminary phase, a respective load of at least one of the electric machines of the at least one drive unit must be reduced and a change of the distribution in the supply network must be carried out. For this change, as regards the current distribution with which a distribution from the energy storage device to the electric machines is established in the supply network, a change-over is made from a first, fixed distribution to a second distribution. In this, during the second distribution to the at least one electric machine in which, during the preliminary phase, a load reduction is to be carried out, a smaller proportion of the current is delivered than is the case during a current distribution with the first distribution.

Operating a drive system in such a manner has the advantage that when carrying out the preliminary phase of the operating mode, in the at least one electric machine in which, during the preliminary phase no load reduction is to be carried out, the current fraction can be increased so that in the electric machine higher power can also be produced. In that way, during the preliminary phase a situation is avoided in which, owing to the first, fixed distribution, a proportion of the current is sent to the at least one electric machine in which the load is to be reduced, which proportion cannot be fully utilized during the load reduction, and which is also insufficient for the operation of the electric machine in which no load reduction is to take place. Overall, therefore, by changing the current distribution the operation of the drive system can be optimized.

According to the invention, therefore, during the operation of the drive system the imminence of an operating mode is recognized, this being done in particular by detecting that there is a corresponding demand to implement the operating mode. The decisive feature of this is that implementing the operating mode makes it necessary to reduce the load in at least one of the electric machines of the at least one electric drive unit. Depending on the operating modes that can in all be realized in the drive system, in this case just one of the operating modes or even several operating modes may satisfy this criterion, so that when the implementation of the operating mode in question is imminent, the preliminary phase is carried out in accordance with the invention.

While carrying out the preliminary phase, in which the load reduction is effected in the at least one electric machine, according to the invention and as regards the current distribution, there is a change from a first, fixed distribution to a second distribution. The second current distribution differs compared with the first current distribution in that during the preliminary phase a smaller current fraction is delivered to the at least one electric machine in which the load is to be reduced, than is the case with the first current distribution. This change of the current fractions then preferably also has the consequence that compared with the fixed current distribution, a higher current fraction is delivered to the at least one further electric machine in which no load reduction is to take place.

Preferably, during the first, fixed distribution there is always a uniform assignment of the current that can be supplied by the energy storage device to the electric machines of the at least one electric drive unit, compared with which the distribution during the second distribution is not uniform.

In accordance with an embodiment of the invention, during a main phase of the operating mode detected that follows the preliminary phase, the electric machine whose load is to be reduced must be operated as a generator, so that during the preliminary phase, by means of the load reduction, the electric machine whose load is to be reduced changes from electric motor operation to generator operation. Thus, during the preliminary phase by virtue of the load reduction, the electric machine whose load is to be reduced is converted from its electric motor operating mode to its generator operating mode, so that the generator operating mode marks the end of the preliminary phase.

In a further development of the above-described embodiment, as a forthcoming operating mode an imminent shifting process in a respective motor vehicle transmission of the at least one electric drive unit is detected, during which, in the main phase, a rotation speed synchronization is carried out in the motor vehicle transmission concerned by the electric machine operating as a generator. Accordingly, in this case the operating mode for which occurrence the load reduction of the at least one electric machine in the preliminary phase is necessary, is a shifting process to be carried out in the motor vehicle transmission concerned. The electric machine operated as a generator in the main phase, i.e., during the rotation speed synchronization in the motor vehicle transmission, then affects the rotation speed synchronization in particular in that the electric machine brakes a particular transmission input of the motor vehicle transmission to a rotation speed required for carrying out the shifting process, namely, the synchronization rotation speed.

Particularly preferably, in a further development of one of the variants of the above-mentioned embodiment the current distribution during the main phase is then changed by comparison with the preliminary phase in such manner that the particular current fraction of at least one further electric machine, which is operated as an electric motor in the at least one drive unit during the main phase, is increased by the amount of current which is made available by the electric machine operating as a generator during that operating mode. This has the advantage that accordingly, with the help of the amount of current produced by the electric machine operating as a generator, the power of the at least one further electric machine can be increased. Furthermore, in that way, in situations in which charging of the electrical energy storage device is not possible, for example owing to the charge condition of the energy storage device or the prevailing temperatures, the inadmissible charging is avoided.

It is an alternative or even supplementary possible embodiment of the invention that as a forthcoming operating mode a decoupling of the electric machine for which load is to be reduced is detected, such that once the load reduction of the electric machine for which load is to be reduced has taken place, in a main phase of the operating mode following the preliminary phase the electric machine is decoupled. Accordingly, the operating mode which according to the invention presupposes a load reduction to be carried out in at least one electric machine during the preliminary phase, is a decoupling process of the at least one electric machine whose load is to be reduced. Once the load reduction has been completed, the electric machine is decoupled. In the context of the invention, the decoupling of this at least one electric machine can for example take place in order, in certain driving situations, to avoid drag operation of that electric machine. In particular, in combination with the aforesaid embodiment, in accordance with the method according to the invention a shifting process and a decoupling process can both be detected.

In a further development of the invention, the second distribution can be designed variably in that in the context of the second distribution percentage current fractions of the electric machines can be chosen as a function of actually necessary individual powers of the electric machines. Advantageously, in that way a feature of the second distribution is that it provides a distribution tailored to requirements.

In accordance with a further embodiment of the invention, compared with the first distribution, the percentage current fractions are changed in the second distribution, this change taking place within a specified limit range. In this case, therefore, the differing structure of the percentage current fractions is set in the second distribution within predetermined limits, for example with two electric machines resulting in a distribution of 80% versus 20%. Advantageously, in this way an excessively unequal current distribution can be avoided.

Alternatively preferred, but supplementary thereto, a change of the current fractions of the electric machines in accordance with the second distribution is limited by current limits set by the power electronics units of the electric machines. In that way, the second distribution can be prevented from supplying too much current to one of the electric machines.

In a further possible design of the invention, when the operating mode has ended, the system reverts to the first distribution. In other words, following the operating mode concerned, the system reverts to its initial condition, namely to the first, fixed current distribution.

In an embodiment of the invention, which in this case is preferably combined with the previous design possibility, during an end phase that terminates the operating mode, a continuous adjustment of the second distribution toward the first distribution takes place. This has the advantage that thereby, at the end of the operating mode, there is no abrupt change to the first current distribution, but the reversion to the first distribution is continuous. In that way, the transition between the two distributions can be smoother.

In a further development of the invention, the respective distribution is designed as a function of prevailing current limits of the energy storage device. In that way, therefore, both the first distribution and the second distribution are established taking into account the prevailing current limits of the energy storage device. In that way, damage to the energy storage device can be avoided.

According to another aspect of the present disclosure, the invention also relates to a control unit for a drive system of a motor vehicle with at least one electric drive unit, in which in each case a plurality of electric machines and an electrical energy storage device are integrated into a supply network. In this case, the control unit is designed, when a forthcoming operating mode is detected, in a preliminary phase prior to its implementation, to carry out a load reduction in at least one of the electric machines of the at least one drive unit, to change the current distribution from the energy storage device to the electric machines established in the supply network from a first, fixed distribution to a second distribution, and thereby, by virtue of the second distribution, during the preliminary phase to assign to the at least one electric machine for which load is to be reduced a smaller fraction of the current than in the first distribution. Particularly preferably, the control unit is also designed to implement one or more of the above-described variants of the method.

The method according to the invention can also be embodied as a computer program product which, when it is run on a processor, for example a processor of a control unit as above, instructs the processor by software means to carry out the associated process steps which are the object of the invention. In this connection, a computer-readable medium is also part of the invention, on which medium the above-mentioned computer program product is stored and can be called up.

### BRIEF DESCRIPTION OF THE DRAWINGS

An advantageous form of the invention, which is explained below, is illustrated in the drawings, which show:

FIG. 1: A schematic representation of a drive system of a motor vehicle; and

FIG. 2: A flow chart of a method for operating the drive system of FIG. 1, in accordance with a preferred embodiment of the invention.

### DETAILED DESCRIPTION

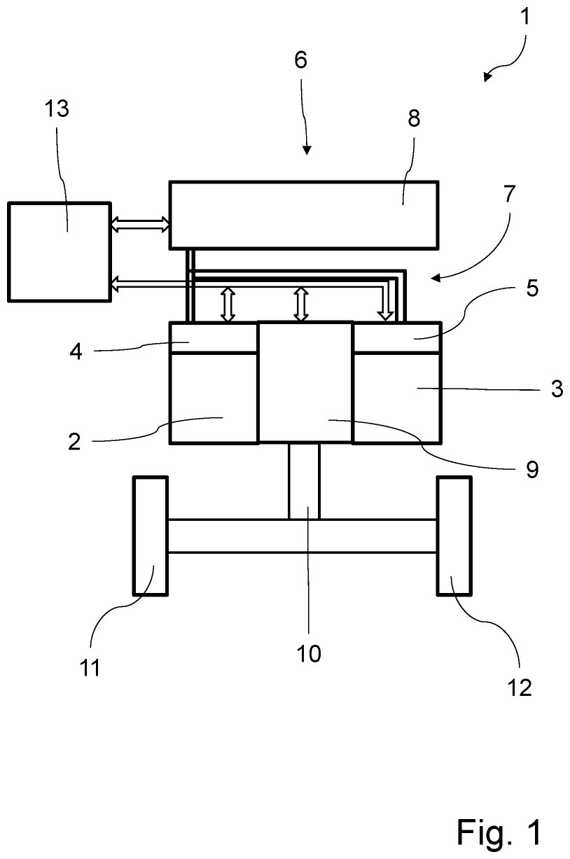

FIG. 1 shows a schematic representation of a drive system 1 of a motor vehicle, such that in this case the drive system 1 preferably consists of an electrically powered motor vehicle drive axle of the motor vehicle. The drive system 1 comprises two electric machines 2 and 3, each of which is associated with a power electronics unit with a respective inverter 4 or 5. The respective electric machines 2 or 3 can be operated by their associated inverters 4 or 5 on the one hand as an electric motor and on the other hand as a generator. Furthermore, each electric machine 2 or 3 can in principle be used as a permanently energized or a remotely energized synchronous machine or as an asynchronous machine.

The two electric machines 2 and 3, together with the associated inverters 4 and 5, are part of an electric drive unit 6 in which the electric machines 2 and 3 with their inverters 4 and 5 are integrated in a supply network 7, such that in the supply network 7 an electrical energy storage device 8 is also provided. The energy storage device 8 is in this case at least one battery in which electrical energy can be stored.

Via drive output shafts—not shown here—the two electric machines 2 and 3 are in each case connected to a common motor vehicle transmission 9 by means of which the electric machine 2 or 3 concerned can be coupled with different gear ratios to a common drive output 10. On the drive output 10 there is then also a differential gearbox—again not shown here—by way of which a coupling is formed to drive wheels 11 and 12 of the drive system 1.

In addition, the drive system 1 comprises a central control unit 13 which can exchange data with the electric machines 2 and 3 and the associated inverters 4 and 5, and which can regulate the operation of the electric machines 2 and 3 by way of their inverters 4 and 5. In addition, data exchange also takes place between the control unit 13 and the energy storage device 8 and the motor vehicle transmission 9, whereby the control unit 13 can also regulate the motor vehicle transmission 9 and in particular shifting processes in the motor vehicle transmission 9.

Thanks to the connections with the energy storage device 8 in the supply network 7, the inverters 4 and 5 and thus also the electric machines 2 and 3 can on the one hand be supplied with electrical energy from the energy storage device 8 to enable each electric machine 2 or 3 to be operated as an electric motor. On the other hand, when an electric machine 2 or 3 is operated as a generator the energy storage device 8 can be supplied with electrical energy and thereby charged.

If both electric machines 2 and 3 are operated in their electric motor mode during the operation of the drive system 1, then in the supply network 7 a fixed current distribution is established from the energy storage device 8 to the two electric machines 2 and 3. In that case, there is a uniform division of the current, wherein current limits are defined by an effective upper limit and an effective lower limit of the energy storage device 8. In certain operating situations of the drive system, however, in the context of the method according to the invention, the system deviates from this fixed current distribution so as to optimize the operation of the two electric machines 2 and 3 in those situations.

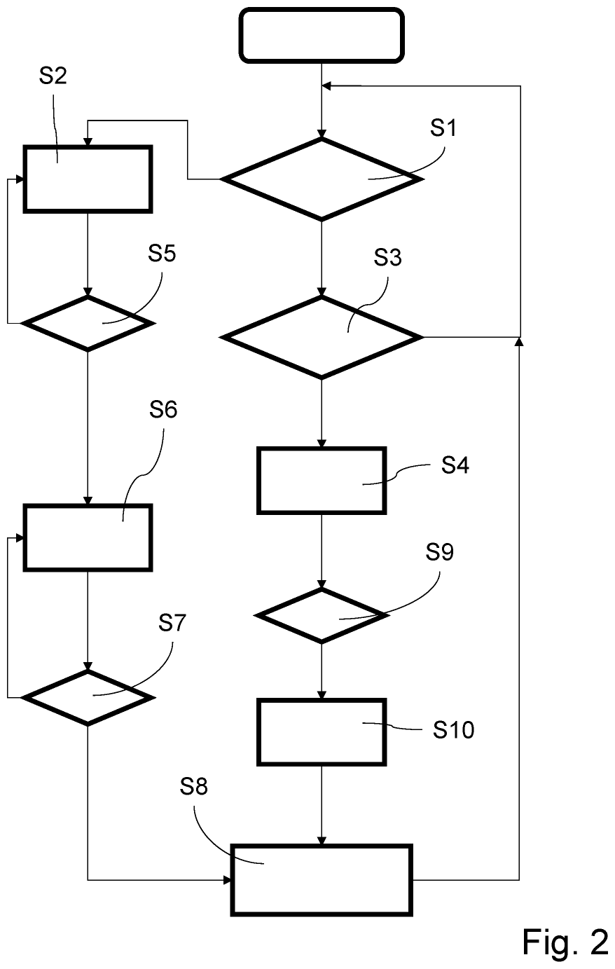

FIG. 2 shows a flow chart of the method according to the invention, such that in what follows the method is described in greater detail. The starting situation of the method is the operation of the drive system 1 with the two electric machines 2 and 3 operating as electric motors and the associated fixed current distribution. In the context of the method according to the invention, in a first step S1 it is then determined whether in the operation of the drive system 1 an operating mode in the form of a shifting process is forthcoming, which to carry out in the motor vehicle transmission 9 one of the electric machines 2 and 3 should be operated in its generator mode for the purpose of rotation speed synchronization. If such a shifting process is forthcoming, then the system moves on to a step S2 whereas otherwise it progresses to a step S3.

If the step S1 is followed by the step 3, i.e., no shifting process in the motor vehicle transmission 9 with generator operation of one of the electric machines 2 or 3 is due to take place, then in step S3 it is checked whether a further operating mode is forthcoming in which one of the electric machines 2 or 3 is to be decoupled by decoupling from the drive output 10. If such a decoupling process is detected in step S3, then step S3 is followed by a step S4, whereas otherwise the system springs back to before step SI and thereafter a new check is carried out as in step S1. Preferably, for this new check the passage of a defined time window is awaited.

If after step S1 the system moves to step S2, i.e., a shifting process in the motor vehicle transmission 9 is imminent, then in step S2 a preliminary phase of that operating mode is initiated. In this preliminary phase, a load reduction in the electric machine 2 or 3 is initiated, which electric machine has to be operated as a generator to carry out a rotation speed synchronization as part of the shifting process. For this, in the preliminary phase in step S2 there is a change from the fixed current distribution to a variable distribution in which, compared with the fixed distribution, the electric machine 2 or 3 in which the load is to be reduced receives a smaller current fraction from the energy storage device 8. Consequently, by virtue of the variable current distribution and compared with the fixed distribution, the electric machine 3 or 2 in which no load reduction is to take place receives a larger current fraction, whereby in the electric machine 3 or 2 where there is to be no load reduction, more power for driving the motor vehicle can be obtained. Thus, by virtue of this variable current distribution the percentage current fractions of the electric machines 2 and 3 are changed to an unequal distribution between the two electric machines 2 and 3. This change takes place within a predetermined limit range, for example to produce a distribution inequality of 80% to 20%.

In a step S5 following step S2, it is then checked whether the load reduction on the electric machine 2 or 3 in which the load is to be reduced has been continued to the point where the electric machine 2 or 3 in which the load is to be reduced has changed from operating as an electric motor to operating as a generator. If that is not the case, i.e., if the electric machine 2 or 3 in which the load is to be reduced is still operating as a motor, then the system springs back to step S2 and the load reduction is therefore continued in accordance with the variable current distribution. On the other hand, if the electric machine 2 or 3 in which the load is to be reduced has changed its operation to the generator mode, then after step S5 the system moves on to a step S6 and thereby the preliminary phase is ended.

In step S6, a main phase of the shifting process in the motor vehicle transmission 9 is carried out, in that the electric machine 2 or 3 then operating as a generator brakes a transmission input of the motor vehicle transmission 9 to obtain a target rotation speed which is required for carrying out the actual shifting process in the motor vehicle transmission 9 (the synchronous rotation speed). During this, as a special feature the amount of current supplied by the electric machine 2 or 3 operating as a generator is fed into the electric machine 3 or 2 operating as an electric motor to drive the motor vehicle, whereby the current fraction supplied to that electric machine 3 or 2 is correspondingly increased.

During this, in a step S7, it is checked continuously whether the shifting process in the motor vehicle transmission 9 has been completed and the main phase of the shifting process is therefore at an end. If this is not the case, the main phase continues in step S6, whereas otherwise the system advances to a step S8. With this step S8, a follow-up phase is carried out, in which the system reverts continuously from the variable current distribution to the fixed current distribution. When the fixed current distribution has been reached, the system springs back again to step S1.

If a transition to step S4 has taken place, i.e., in advance of a forthcoming decoupling process that has been detected, then in step S4 a preliminary phase of this decoupling process is initiated. In this preliminary phase, a load reduction of the electric machine 2 or 3 to be decoupled begins, and in the preliminary phase a change from the fixed current distribution to a variable distribution also takes place in which the electric machine 2 or 3, in which the load is to be reduced and which is to be decoupled, receives a smaller current fraction from the energy storage device compared with the fixed distribution. Thereby, compared with the fixed distribution the electric machine 3 or 2 whose load is not to be reduced receives a larger current fraction so that the electric machine 3 or 2 whose load is not to be reduced can be operated with more power for driving the motor vehicle. As in step S2, by virtue of the variable current distribution, the percentage current fractions of the electric machines 2 and 3 are changed to an unequal distribution, this change taking place within a predetermined limit range, for example to a distribution inequality of 80% to 20%.

In a step S9, it is checked continuously whether the load reduction to be carried out in the electric machine 2 or 3 to be decoupled has been completed. If that is not the case, then the preliminary phase is continued as in step S4, whereas otherwise the system advances to a step S10. In this step S10, the main phase of the decoupling process is carried out in that the electric machine 2 or 3 is actually decoupled. At the end of step S10 the system then advances to step S8 and thereby initiates the follow-up phase in which the system reverts continuously from the variable current distribution to the fixed current distribution. In addition, as already described, when step S8 has ended the system springs back to before step S1.

By virtue of the operation of a drive system in accordance with the invention, the operation of electric machines of an electric drive unit during the implementation of an operating mode can be optimized.

### Indexes

1 Drive system
2 Electric machine
3 Electric machine
4 Inverter
5 Inverter
6 Drive unit
7 Supply network
8 Energy storage device
9 Motor vehicle transmission
10 Drive output
11 Drive wheel
12 Drive wheel
13 Control unit
S1 to S10 Individual steps

1. A method for operating s drive system (1) of a motor vehicle having at least one electric drive unit (6), a plurality of electric machines (2, 3), and an electrical energy storage device (8) are integrated in a supply network (7), the method comprising:
detecting a forthcoming operating mode in the motor vehicle
reducing a load, in a preliminary phase, in at least one of the electric machines (2, 3) of the at least one drive unit (6); and
changing a current distribution in the supply network (7) from the energy storage device (8) to the electric machines (2, 3) from a first, fixed distribution to a second distribution, in such manner that during the preliminary phase a smaller current fraction is assigned to the at least one electric machine (2; 3) in which the load is to be reduced than in the first distribution.

2. The method according to claim 1, comprising:
operating the electric machine (2, 3) as a generator, in a main phase of the detected forthcoming operating mode that follows the preliminary phase, so that in the preliminary phase, by virtue of reducing the load, the electric machine (2; 3) in which the load is to be reduced changed from operating as an electric motor to operating as a generator.

3. The method according to claim 2, comprising:
detecting, as a forthcoming operating mode, an imminent shifting process in a respective motor vehicle transmission (9) of the at least one electric drive unit (6); and
synchronizing a rotation speed in the motor vehicle transmission (9) concerned during the main phase by means of the electric machine (2; 3) operated as a generator.

4. The method according to Claim 3, comprising:
changing, during the main phase, the current distribution compared with the preliminary phase, in such manner that the respective current fraction of at least one further electric machine (3; 2), which during the main phase is operating as an electric motor in the at least one drive unit (6), is increased by the amount of current provided by the electric machine (2; 3) which is operating as a generator during the operating mode.

5. The method according to Claim 1, comprising:
detecting, as an imminent operating mode, a decoupling process of the electric machine (2; 3) whose load is to be reduced; and
decoupling the electric machine during a main phase following the preliminary phase, after reducing the load in the electric machine (2; 3) whose load was to be reduced.

6. The method according to Claim 1, wherein the second distribution is structured as variable, in that in the second distribution percentage current fractions of the electric machines (2, 3) are determined as a function of the currently needed powers of the electric machines.

7. The method according to claim 1, wherein in the second distribution, compared with the first distribution, the percentage current fractions are changed in such manner that the change is carried out within a predetermined limit range.

8. The method according to claim 1, wherein a change of the current fractions of the electric machines (2, 3) occurring during the second distribution is limited by current limits determined by power electronic units of the electric machines (2; 3).

9. The method according to Claim 1, comprising reverting to the first distribution once the implementation of the operating mode has been completed.

10. The method according to Claim 9, wherein during the course of a follow-up phase after the operating mode concerned, the second distribution reverts back to the first distribution in a continuous manner.

11. The method according to Claim 1, wherein each of the distributions is configured as a function of effective current limits of the energy storage device (8).

12. A control unit (13) for a drive system (1) of a motor vehicle having at least one electric drive unit (6), a plurality of electric machines (2, 3), and an electrical energy storage unit (8) are integrated in a supply network (7), wherein the control unit (13) is configured, when a forthcoming operating mode is detected, in order to carry out the operating mode, in advance and in a preliminary phase a load reduction is carried out in at least one of the electric machines (2, 3) of the at least one drive unit (6), a current distribution established in the supply network (7), of the current supplied by the energy storage device (7) to the electric machines (2, 3) is changed from a first, fixed distribution to a second distribution, and thereby, during the preliminary phase, a smaller current fraction is supplied by virtue of the second distribution to the electric machine (2; 3) whose load is to be reduced than the fraction supplied thereto during the first distribution.

13. The control unit (13) according to claim 12, further configured to operate the electric machine (2, 3) as a generator in a main phase of the detected forthcoming operating mode that follows the preliminary phase, so that in the preliminary phase, by virtue of reducing the load, the electric machine (2; 3) in which the load is to be reduced changes from operating as an electric motor to operating as a generator.

14. A computer program product for a control unit (13) of a motor vehicle comprising computer-executable coded that, when executed by a computer, performs the method of claim 1.

15. (canceled)
